(19) United States
(12) Patent Application Publication
(10) Pub. No.: US 2025/0130050 A1
(43) Pub. Date: Apr. 24, 2025

(54) METHOD FOR OPERATING A SURROUNDINGS ACQUISITION DEVICE OF A VEHICLE, VEHICLE, AND SYSTEM FOR GENERATING MAP DATA

(71) Applicant: Robert Bosch GmbH, Stuttgart (DE)

(72) Inventors: Jan Rohde, Stuttgart (DE); Benedikt Loesch, Stuttgart (DE); Steffen Bucher, Leonberg (DE)

(21) Appl. No.: 18/899,262

(22) Filed: Sep. 27, 2024

(30) Foreign Application Priority Data
Oct. 18, 2023 (DE) 10 2023 210 177.7

(51) Int. Cl. G01C 21/34; H04W 4/029; H04W 4/40

(52) U.S. Cl. CPC G01C 21/3407; H04W 4/029; H04W 4/40

(57) ABSTRACT

A method for operating a surroundings acquisition device of a vehicle. An evaluation unit of the vehicle receives an external acquisition request that contains at least one request assignment in which a request enable signal is assigned to a specific region of a map and a specific time-of-day interval, wherein the evaluation unit uses the map to ascertain whether the vehicle is in the specific region during the time-of-day interval, and wherein the surroundings acquisition device is activated by means of the evaluation unit using the request enable signal when the vehicle is in the specific region during the time-of-day interval.

### CROSS REFERENCE

The present application claims the benefit under 35 U.S.C. § 119 of German Patent Application No. DE 10 2023 210 177.7 filed on Oct. 18, 2023, which is expressly incorporated herein by reference in its entirety.

### FIELD

The present invention relates to a method for operating a surroundings acquisition device of a vehicle. The present invention moreover relates to a vehicle comprising at least one surroundings acquisition device and at least one evaluation unit. The present invention also relates to a system for generating map data for the operation of automated and/or assistive vehicle systems of vehicles comprising at least one central data processing device and at least one vehicle.

### BACKGROUND INFORMATION

The acquisition of the surroundings of the vehicle using an on-board perception system based on sensors, such as a radar sensor and/or a video camera, is a fundamental component of modern automated vehicle systems (AD systems) and assistive vehicle systems (DA systems). The environment models used in this context are often supplemented with additional map information, such as the course of the roadway. The map data used for this purpose, for example in the form of map products such as planning maps, behavior maps and/or localization maps, can be made available to the respective vehicle system via a map service.

To create maps or generate map data, fleet data that can be transmitted from fleet vehicles to a cloud system, i.e. a fleet cloud, can be used. From the fleet cloud, the map data can be transmitted further to a fleet data map creation cloud and processed there, in particular to create the abovementioned map products. The amount of fleet data needed to achieve a given level of quality of the respective map product has a direct impact on the cost-efficiency of the business model of the map service.

To create the maps, fleet data for regions of maps to be mapped and/or monitored can be requested and transmitted without the need for a targeted selection. Algorithms for creating, expanding and/or updating maps for use in automated and/or assistive vehicle systems are described in the related art.

Methods with which high-resolution radar data can be obtained with a MIMO antenna array of a vehicle are described in German Patent Application Nos. DE 10 2014 212 280 A1, DE 10 2014 212 284 A1 and DE 10 2017 200 317 A1.

### SUMMARY

The present invention provides a method for operating a surroundings acquisition device of a vehicle, with which a location- and time-dependent activation of the surroundings acquisition device is possible to be able to use the surroundings acquisition device to obtain surroundings data in at least one specific region included in a map during the specific time-of-day interval in order to generate improved map data, i.e., in particular information relating to the specific region that is updated and/or optimized in terms of its accuracy.

According to an example embodiment of the present invention, the specific region and the specific time-of-day interval can be made available to the electronic evaluation unit of the vehicle, for example via the external acquisition request. The external acquisition request can be generated by an off-board, i.e., external, for example central, data processing device, and sent to the vehicle. Alternatively, at least the specific region can be ascertained using the on-board evaluation unit.

According to an example embodiment of the present invention, the evaluation unit can use the map to ascertain whether the vehicle is in the specific region during the specific time-of-day interval. The evaluation unit can ascertain whether the vehicle is in the specific region using GPS data, for instance, and/or by comparing surroundings features or unique surroundings feature combinations acquired by the surroundings acquisition device with surroundings features or unique surroundings feature combinations included in the map data or in the map of the specific region. If the evaluation unit simultaneously determines that the specific time-of-day interval is currently a given, the activation unit activates the surroundings acquisition device using the request assignment or the request enable signal contained therein to acquire surroundings information or to generate corresponding surroundings data.

Surroundings information can thus be acquired in a highly targeted manner and used to generate map data based on which maps or map products can be created and/or updated. This makes it possible to significantly improve the precision and efficiency of a mapping system used to create maps or map products.

The resulting improvement in the quality of maps or map products that can be made available to a vehicle system also makes it possible for a self-localization, in particular radar-based self-localization, of a vehicle to be carried out with significantly more precision. The performance of a self-localization of a vehicle can therefore be improved over the related art. The improved quality of the maps or map products can be manifest as improved efficiency (improved data rate) and/or improved effectiveness (improved data quality).

According to one advantageous configuration of the present invention, the surroundings acquisition device is activated by means of the evaluation unit using the request enable signal to carry out a precision operation in which the surroundings acquisition device generates surroundings data with higher accuracy and/or higher resolution than in a normal operation. The activation of the surroundings acquisition device using the request enable signal therefore causes the surroundings acquisition device to switch from its normal operation to precision operation.

According to an example embodiment of the present invention, in precision operation, the data rate of the surroundings data generated by the surroundings acquisition device used to generate maps, for example, can be increased compared to normal operation. The hardware resources used for self-localization and/or map creation can be advantageously influenced as well, for example by temporarily increasing the availability of the hardware resources for self-localization.

According to an example embodiment of the present invention, in precision operation, optimized radar data are generated for mapping or map creation and self-localization without having to use a specially optimized sensor. Instead, a standard sensor used for functions such as ACC or AEB can be used to its full capacity for this purpose. The optimization of the radar data can be achieved using one or more of the methods described below.

According to an example embodiment of the present invention, to carry out a feature-based self-localization process, a map product in the form of a localization map can be made available to an on-board localization system. The localization map can, for instance, include at least one unique feature combination in a specific region to be used for a highly accurate self-localization. Alternatively or additively, the localization map can include at least one specific region with a few unique feature combinations. In such a specific region, the surroundings acquisition device can be operated in precision operation in the specific time-of-day interval, which enables a more accurate self-localization of the vehicle. Alternatively or additively, the localization map can include critical specific regions in which increased self-localization accuracy and/or self-localization reliability is required from a functional point of view, for example at intersections or the like. The aforementioned information relating to specific regions of the localization map can be generated away from the vehicle or by a component, for example the evaluation unit, of the vehicle. As soon as the vehicle is in an aforementioned specific region during the specific time-of-day interval, the surroundings acquisition device can be activated using the request enable signal to start the precision operation of the surroundings acquisition device.

In the case of a radar-based surroundings acquisition device, the precision operation of the surroundings acquisition device is preferably carried out in such a way that additional modulations are generated for a limited period of time to meet thermal requirements and emission requirements.

Pauses between measurement cycles can be shortened or eliminated entirely, for example. Because this increases the thermal load on the sensor, this operating mode can only be maintained for a short time, for example for a few seconds. Such an additional modulation can have a special chirp sequence that enables an increased resolution of the specific geographic region. For instance, the bandwidth and/or measurement duration can be increased. The vehicle movement can also be taken into account here. The information of multiple successive modulation cycles can be processed coherently, for example. The vehicle movement therefore has to be taken into account in the evaluation in order to thus compensate for the “migration of stationary targets”. Alternatively, the modulation duration of a single measurement cycle can be increased, which also achieves an increased resolution and likewise requires the vehicle movement to be taken into account. Alternatively or additively, an increased sampling rate of the time signal (for example from 10 MHz to 20 MHz) and/or an increased bandwidth of the chirp sequence with optional binning for distance ranges or range bins outside of the specific geographic region can be used in the precision operation. Alternatively or additively, the focus of the evaluation can be placed on a specific elevation range in which most of the mapping-relevant targets are expected by coherent integration of the individual modulation sequences of a modulation according to German Patent Application Nos. DE 10 2014 212 280 A1, DE 10 2014 212 284 A1 or DE 10 2017 200 317 A1 and beamforming of the individual channels. In coherent integration, the data of the individual modulation sequences which are offset in time to one another are summed at the correct phase using the vehicle speed, which leads to an improved signal-to-noise ratio. When beamforming the channels, the received signals are summed at the correct phase for a specific elevation direction, so that targets from this direction are amplified and targets at strongly deviating elevation angles are attenuated. The relevant elevation angle range is around 0° in relation to the vehicle. If the radar sensor is misaligned with respect to the elevation, the preferred direction may also deviate from 0°.

According to an example embodiment of the present invention, to further increase the precision of the evaluation of radar signals from the surroundings acquisition device by means of the evaluation unit, the specific geographic region can be projected into a distance-speed-space before targets are detected; i.e. with knowledge of the vehicle speed and the installation angle of the sensor, the expected measured variables distance and speed can be calculated for a specific Cartesian position or a specific region. All of the targets can then be evaluated in this projected specific region (region of interest (ROI)) in the distance-speed space; i.e. their distance, speed and angle can be determined. This eliminates the usual target detection using a CFAR algorithm and the usual peak search. Distance-speed spectral data of the projected specific region can alternatively be transmitted to an external data processing device and thus evaluated outside of the vehicle. The spectral data here comprises the complex received signals of all of the transmitting and receiving antennas and, if applicable, also the data of the multiple modulation sequences. High-resolution algorithms can also be activated for the projected specific region in order to achieve an increased separation capability in distance-speed. There are a variety of approaches, such as MUSIC; ESPRIT, maximum likelihood methods, for this in the literature. The received signal is modeled here as a superposition of multiple targets and the conventional methods from the literature achieve a separation capability that is increased by a factor of 2 to 3. Optimum utilization of the memory capacity and the computing capacity of the surroundings acquisition device can be realized by enabling only a short-term increase in data rate and quality that is possibly also limited to subregions of the distance-speed space. The use of the high-resolution algorithms is limited to relevant regions and activated only when the increased separation capability is needed for this region. The precision operation is preferably selected such that the generation of waste heat by the surroundings acquisition device is limited and high-frequency emission limits are observed.

According to another advantageous embodiment of the present invention, in normal operation of the surroundings acquisition device, the evaluation unit uses the map and the surroundings data to ascertain whether the surroundings of the vehicle are being acquired by the surroundings acquisition device with a minimum quality, wherein the surroundings acquisition device is activated by means of the evaluation unit using the request enable signal only if the surroundings of the vehicle are being acquired by the surroundings acquisition device with the minimum quality or with a quality above the minimum quality. The minimum quality can be included in the acquisition request. If the specific region for the observation region of the surroundings acquisition device is partially or completely obscured, for example by other road users, and/or there is interference from reflected radar signals with free input signals and/or there are ghost targets in the specific region, there is no need to activate the surroundings acquisition device by means of the request enable signal. This is useful in particular when the processing of the high-resolution surroundings data of the precision operation can no longer take place in real time, but instead requires several measurement cycles.

According to another advantageous embodiment of the present invention, the surroundings acquisition device is activated by means of the evaluation unit using the request enable signal such that a specific observation angle range of the surroundings of the vehicle in the specific region is acquired with the surroundings acquisition device. The specific observation angle range can be included in the acquisition request. For example, only a subregion of the specific region in which a specific feature combination is to be expected can be observed or examined by means of the surroundings acquisition device.

A further subject matter of the present invention is a vehicle comprising at least one surroundings acquisition device and at least one evaluation unit, wherein the evaluation unit is configured to receive an external acquisition request that contains at least one request assignment in which a request enable signal is assigned to a specific region of a map and a specific time-of-day interval, to ascertain whether the vehicle is in the specific region during the time-of-day interval, and to activate the surroundings acquisition device using the request enable signal when the vehicle is in the specific region during the time-of-day interval.

The advantages mentioned above with reference to the method of the present invention are correspondingly associated with the vehicle of the present invention. The vehicle can in particular be used to carry out the method according to one of the abovementioned embodiments or a combination of at least two of these embodiments with one another. Advantageous embodiments of the method can correspond to advantageous embodiments of the vehicle. The vehicle can in particular be configured as a land vehicle, for example a motor vehicle. The vehicle can be configured for autonomous driving. The surroundings acquisition device can be radar-based and/or video-based.

According to one advantageous configuration of the present invention, the evaluation unit is configured to activate the surroundings acquisition device using the request enable signal to carry out a precision operation in which the surroundings acquisition device generates surroundings data with higher accuracy and/or higher resolution than in a normal operation. The advantages mentioned above with reference to the respective embodiment of the method are correspondingly associated with this embodiment.

According to another advantageous embodiment of the present invention, the evaluation unit is configured to, in normal operation of the surroundings acquisition device, use the map and the surroundings data to ascertain whether the surroundings of the vehicle are being acquired by the surroundings acquisition device with a minimum quality, and to activate the surroundings acquisition device using the request enable signal only if the surroundings of the vehicle are being acquired by the surroundings acquisition device with the minimum quality or with a quality above the minimum quality. The advantages mentioned above with reference to the respective embodiment of the method are correspondingly associated with this embodiment.

According to another advantageous embodiment of the present invention, the evaluation unit is configured to activate the surroundings acquisition device using the request enable signal such that a specific observation angle range of the surroundings of the vehicle in the specific region is acquired with the surroundings acquisition device. The advantages mentioned above with reference to the respective embodiment of the method are correspondingly associated with this embodiment.

A further subject matter of the present invention is a system for generating map data for the operation of automated and/or assistive vehicle systems of vehicles, comprising at least one central data processing device and at least one vehicle configured according to one of the abovementioned configurations or a combination of at least two of these configurations with one another.

The advantages mentioned above with reference to the method or the vehicle of the present invention are correspondingly associated with the system of the present invention. The system can in particular be used to carry out the method according to one of the abovementioned embodiments or a combination of at least two of these embodiments with one another. Advantageous embodiments of the method can correspond to advantageous embodiments of the system. The central data processing device can be cloud-based.

According to one advantageous configuration of the present invention, the central data processing device is configured to ascertain a quality of map data assigned to a specific region of a map, to generate an acquisition request that contains at least one request assignment in which a request enable signal is assigned to the specific region of the map and a specific time-of-day interval and, if the quality of the map data assigned to the specific region of the map is below a given minimum quality value, send the acquisition request to the vehicle. The specific time-of-day interval can be created on the basis of fleet statistics, for example, for instance to generate a prioritization of recording times for needed fleet data. The specific time-of-day interval can be a time interval in which the traffic density in the specific region is low, for instance; this can be ascertained from the fleet statistics. When selecting the respective specific region of the map, the relevance of specific geographic regions can be taken into account, for example. For instance, a region with outdated data or a corner case for driving functions can be selected as the specific region of the map. Fleet data can therefore be requested very specifically by means of acquisition requests and then used to create the maps. As soon as the required amount of data has been received, the generation and transmission of acquisition requests to vehicles can be terminated.

The present invention will be explained in the following using the figures and preferred embodiments as examples, wherein the features discussed in the following can represent an advantageous and/or further developing aspect of the present invention both individually and in different combinations of at least two of these features with one another.

### BRIEF DESCRIPTION OF THE DRAWINGS

FIG. 1 shows a block diagram of an embodiment example for a system according to the present invention.

FIG. 2 shows a block diagram of an embodiment example for a vehicle according to the present invention.

### DETAILED DESCRIPTION OF EXAMPLE EMBODIMENTS

In the figures, same or functionally same components are provided with the same reference signs. A repeated description of such components can be omitted to avoid unnecessary repetitions.

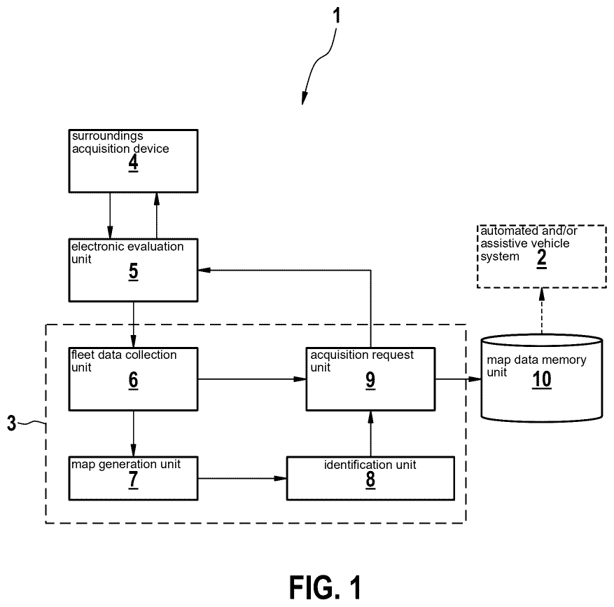

FIG. 1 shows a block diagram of an embodiment example for a system 1 according to the present invention for generating map data for the operation of an automated and/or assistive vehicle system 2 of a not depicted vehicle. The system 1 comprises a central data processing device 3 and the vehicle. The vehicle comprises a radar-based surroundings acquisition device 4 and an electronic evaluation unit 5.

The surroundings of the vehicle are at least partially acquired by the surroundings acquisition device 4. The surroundings acquisition device 4 generates corresponding surroundings data that are sent from the surroundings acquisition device 4 to the evaluation unit 5, which collects the received surroundings data. From the collected surroundings data, the evaluation unit 5 can generate fleet data which are sent from the evaluation unit 5 to a fleet data collection unit 6 of the central data processing device 3. Data can be sent from the fleet data collection unit 6 to a map generation unit 7 of the central data processing device 3. The map generation unit 7 can send data to an identification unit 8 of the central data processing device 3, wherein the identification unit 8 is configured to identify specific regions of a map the quality and/or up-to-dateness of which is insufficient from the received data. The identification unit 8 can be in particular configured to ascertain a quality of map data assigned to a specific region of a map. The identification unit 8 can send corresponding data to an acquisition request unit 9 of the central data processing device 3, which can also be sent data from the fleet data collection unit 6, wherein this data can in particular be data related to travel by a large number of fleet vehicles. Based on the received data, the acquisition request unit 9 can generate an acquisition request and send it to the evaluation unit 5. This external acquisition request includes at least one request assignment in which a request enable signal is assigned to a specific region of a map identified by the identification unit 8 and a specific time-of-day interval. The acquisition request is in particular generated if the quality of the map data assigned to the specific region of the map is below a given minimum quality value. The evaluation unit 5 uses the map to ascertain whether the vehicle is in the specific region during the specific time-of-day interval. If this is the case, the surroundings acquisition device 4 is activated by means of the evaluation unit 5 using the request enable signal. The acquisition request unit 9 can also send data to a map data memory unit 10 of the vehicle, where the data is then stored. The map data memory unit 10 can send map data to the vehicle system 2 so that it can carry out its functions.

The surroundings acquisition device 4 is activated by means of the evaluation unit 5 using the request enable signal to carry out a precision operation in which the surroundings acquisition device 4 generates surroundings data with higher accuracy and/or higher resolution than in a normal operation. In normal operation of the surroundings acquisition device 4, the evaluation unit 5 uses the map and the surroundings data to ascertain whether the surroundings of the vehicle are being acquired by the surroundings acquisition device 4 with a minimum quality, wherein the surroundings acquisition device 4 is activated by means of the evaluation unit 5 using the request enable signal only if the surroundings of the vehicle are being acquired by the surroundings acquisition device 4 with the minimum quality or with a quality above the minimum quality.

The surroundings acquisition device 4 can also be activated by means of the evaluation unit 5 using the request enable signal such that a specific observation angle range of the surroundings of the vehicle in the specific region is acquired with the surroundings acquisition device 4.

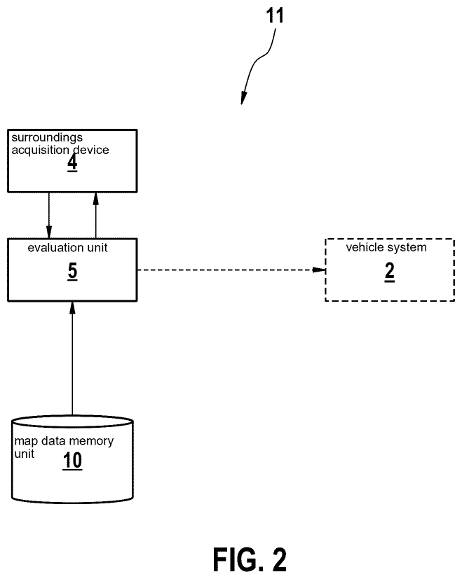

FIG. 2 shows a block diagram of an embodiment example for a vehicle 11 according to the present invention. The vehicle 11 comprises a surroundings acquisition device 4 and an evaluation unit 5.

The surroundings of the vehicle are at least partially acquired by the surroundings acquisition device 4. The surroundings acquisition device 4 generates corresponding surroundings data that are sent from the surroundings acquisition device 4 to the evaluation unit 5. The evaluation unit 5 is also supplied with map data from a map data memory unit 10 of the vehicle 11. The evaluation unit 5 can ascertain a self-localization of the vehicle 11 by comparing the surroundings data with the map data.

The evaluation unit 5 is configured to receive an external acquisition request that contains at least one request assignment in which a request enable signal is assigned to a specific region of a map and a specific time-of-day interval, to ascertain using the map data whether the vehicle 11 is in the specific region during the time-of-day interval, and to activate the surroundings acquisition device 4 using the request enable signal when the vehicle 11 is in the specific region during the time-of-day interval.

The evaluation unit 5 is further configured to ascertain a vehicle pose from the map data and surroundings data and send corresponding data to the vehicle system 2.

The evaluation unit 5 is also configured to activate the surroundings acquisition device 4 using the request enable signal to carry out a precision operation in which the surroundings acquisition device 4 generates surroundings data with higher accuracy and/or higher resolution than in a normal operation. The evaluation unit 5 is configured to, in normal operation of the surroundings acquisition device 4, use the map and the surroundings data to ascertain whether the surroundings of the vehicle 11 are being acquired by the surroundings acquisition device 4 with a minimum quality, and to activate the surroundings acquisition device 4 using the request enable signal only if the surroundings of the vehicle 11 are being acquired by the surroundings acquisition device 4 with the minimum quality or with a quality above the minimum quality.

The evaluation unit 5 can moreover be configured to activate the surroundings acquisition device 4 using the request enable signal such that a specific observation angle range of the surroundings of the vehicle 11 in the specific region is acquired with the surroundings acquisition device 4.

What is claimed is:

1. A method for operating a surroundings acquisition device of a vehicle, the method comprising the following steps:
receiving, by an evaluation unit of the vehicle, an external acquisition request that contains at least one request assignment in which a request enable signal is assigned to a specific region of a map and a specific time-of-day interval;
ascertain, using the map, whether the vehicle is in the specific region during the time-of-day interval; and
activating, by the evaluation using the request enable signal, the surroundings acquisition device, when the vehicle is in the specific region during the time-of-day interval.

2. The method according to claim 1, wherein the surroundings acquisition device is activated by the evaluation unit using the request enable signal to carry out a precision operation in which the surroundings acquisition device generates surroundings data with higher accuracy and/or higher resolution than in a normal operation.

3. The method according to claim 2, wherein, in the normal operation of the surroundings acquisition device, the evaluation unit uses the map and the surroundings data to ascertain whether the surroundings of the vehicle are being acquired by the surroundings acquisition device with a minimum quality, wherein the surroundings acquisition device is activated by the evaluation unit using the request enable signal only when the surroundings of the vehicle are being acquired by the surroundings acquisition device with the minimum quality or with a quality above the minimum quality.

4. The method according to claim 1, wherein the surroundings acquisition device is activated by the evaluation unit using the request enable signal such that a specific observation angle range of the surroundings of the vehicle in the specific region is acquired with the surroundings acquisition device.

5. A vehicle, comprising:
at least one surroundings acquisition device; and
at least one evaluation unit, wherein the evaluation unit is configured to receive an external acquisition request that contains at least one request assignment in which a request enable signal is assigned to a specific region of a map and a specific time-of-day interval, to ascertain whether the vehicle is in the specific region during the time-of-day interval, and to activate the surroundings acquisition device using the request enable signal when the vehicle is in the specific region during the time-of-day interval.

6. The vehicle according to claim 5, wherein the evaluation unit is configured to activate the surroundings acquisition device using the request enable signal to carry out a precision operation in which the surroundings acquisition device generates surroundings data with higher accuracy and/or higher resolution than in a normal operation.

7. The vehicle according to claim 6, wherein the evaluation unit is configured to, in normal operation of the surroundings acquisition device, use the map and the surroundings data to ascertain whether the surroundings of the vehicle are being acquired by the surroundings acquisition device with a minimum quality, and to activate the surroundings acquisition device using the request enable signal only if the surroundings of the vehicle are being acquired by the surroundings acquisition device with the minimum quality or with a quality above the minimum quality.

8. The vehicle according to claim 5, wherein the evaluation unit is configured to activate the surroundings acquisition device using the request enable signal such that a specific observation angle range of the surroundings of the vehicle in the specific region is acquired with the surroundings acquisition device.

9. A system for generating map data for operation of an automated and/or assistive vehicle system of a vehicle, the system comprising:
at least one central data processing device; and
at least one vehicle including:
at least one surroundings acquisition device, and
at least one evaluation unit, wherein the evaluation unit is configured to receive an external acquisition request that contains at least one request assignment in which a request enable signal is assigned to a specific region of a map and a specific time-of-day interval, to ascertain whether the vehicle is in the specific region during the time-of-day interval, and to activate the surroundings acquisition device using the request enable signal when the vehicle is in the specific region during the time-of-day interval.

10. The system according to claim 9, wherein the central data processing device is configured to ascertain a quality of map data assigned to a specific region of a map, to generate an acquisition request that contains at least one request assignment in which a request enable signal is assigned to the specific region of the map and a specific time-of-day interval and, if the quality of the map data assigned to the specific region of the map is below a given minimum quality value, send the acquisition request to the vehicle.
